(19) United States
(12) Patent Application Publication
(10) Pub. No.: US 2008/0263932 A1
(43) Pub. Date: Oct. 30, 2008

(54) Swivel point fish gig

(76) Inventor: Ramion Clayton Butler, Santa Fe, TX (US)

Correspondence Address: DELPHINE M. JAMES, 2656 SOUTH LOOP WEST #170, HOUSTON, TX, 77054, US

(21) Appl. No.: 11/789,358

(22) Filed: Apr. 24, 2007

(51) Int. Cl. A01K 81/04

(52) U.S. Cl. 43/6

(57) ABSTRACT

A simple efficient novel design fishing spear assembly for sport fishing includes a spear point pivotally mounted to the upper end of a spear shaft. The spear point swivels from 0 degrees to 180 degrees. The spear point and shaft is mounted onto a long handle to support under water spear fishing, wade fishing, spear fishing or gig fishing from vessel. The ranges of rotation support the spear point between an insertion position, a retaining position, and a withdrawal position. A ball cooperatively engaging with a locking mechanism secures the spear point within the desired position. The long handle can range from a few feet to several feet depending on the application or need.

### BACKGROUND

This invention relates to fishing spears. The sport of spear fishing is well known in the art. The use of fishing spears is also well known in the art. Normally, the fishing spear is adapted with a mechanism for retaining the speared fish on the spear while awaiting manual removal of the fish from the spear.

One example of such is a spear is U.S. Pat. No. 4,982,523. However, the present invention is a new novel design of a fishing spear.

### SUMMARY

One of the main objectives of the present invention is to provide an improved simple fishing spear gig that has structural integrity to support sports fishing.

The present invention includes a spear shaft with a pivotally mounted spear point or gig mounted onto a long handle. The spear point swivels from 0 degrees to 180 degrees within a slot within the upper end of spear shaft. The ranges of rotation support the spear point between an insertion position, a retaining position, and a withdrawal position. A ball and complementary locking mechanism secures the spear point within the desired position. The long handle can range from a few feet to several feet depending on the application or need.

The foregoing and other features of the present invention will become more apparent from the following description and accompanying drawings.

### DRAWINGS

FIG. 1A is a frontal view of the fishing spear of the present invention.

FIG. 1B is a side view of the fishing spear with the spear point secured in its insertion position.

FIG. 1C is a side view of the fishing spear with the spear point pivoted to its retaining position.

FIG. 1D is a side view of the fishing spear with the spear point pivoted to its withdrawal position.

FIG. 2A is a side view of the fishing spear with the spear point speared into a fish.

FIG. 2B is a side view of the fishing spear with the spear point pivoted to its retaining position within the fish.

FIG. 2C is a side view of the fishing spear with the spear point pivoted to its removal position while speared within the fish.

### DETAIL DESCRIPTION

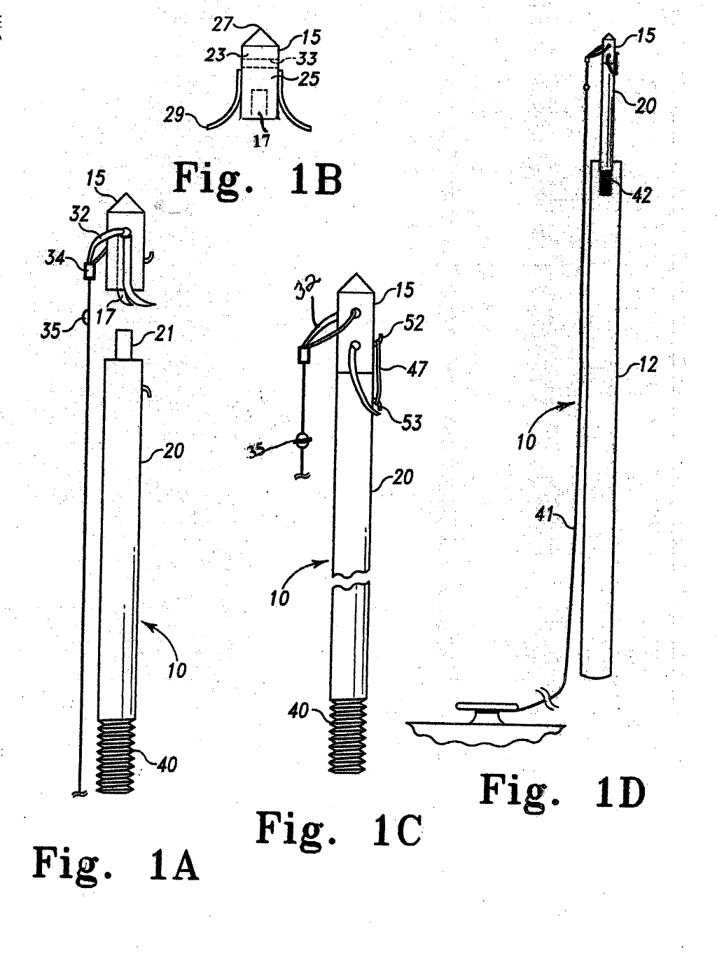

Referring to FIG. 1A, there is shown one embodiment of the present invention, a fishing pole 10. Fishing pole 10 further includes handle 15 removable attached to the lower end 21 of spear shaft 20. As shown, handle is an elongated cylindrical pole with a larger diameter than spear shaft 20.

As shown in FIG. 1A, spear shaft 20 further comprises a pair of parallel prongs 12 and 14 extending integrally and linearly from the upper end of spear shaft 20 to a predetermined point within spear shaft 20 to form slot 16. Spear point 25 is placed within slot 16 and is pivotally attached thereto by a securing pin 32 laterally extending through prongs 12 and 14 and hole 22 within spear point 25.

Spear shaft 20 is an elongated cylindrical pole with external threads 42 affixed to its lower end. Positioned within the upper end of handle 15 is an internally threaded bore 40 for cooperatively receiving and engaging the external threads 42 affixed to the lower end 21 of spear shaft 20 shown in FIG. 1B. Threading is only one mechanism of securing spear shaft 20 to handle 15.

The main body of spear point 25 is substantially rectangular in shape. At one end of spear point 25 is a triangular shape blade with edges 51 and 52 terminating in apex point 50. At the other end of spear point 25 is linear edge 58 that tapers outwardly and upwardly to retaining ear 36. Retaining ear 36 is affixed to upper edge of spear point 25 and slightly curves upward therefrom. A pair of balls 30 and 34 is affixed on opposing sides of spear point 25 with securing pin 32 there between.

Situated below securing pin 32 within prongs 12 and 14 is a retaining ball-lock mechanism 30 for receiving and securely engaging ball 30 or 34. Ball-lock mechanism 30 prevents spear point from prematurely releasing from its secured pivoted position prior to impact of spear point 25 with the body of the fish as explained below. In this embodiment ball lock mechanism is an aperture large enough to receive and securely engage ball 31 or 34.

As shown in FIG. 1B, in its normal insertion position spear point 25 is pivoted such that the longitudinal axis 26 of spear point 25 is aligned with the longitudinal axis 27 of spear shaft 20 with point 50 facing outward of slot 16. This is considered spear point zero degree position. Ball 34 contacts retaining mechanism 31 and is securely engaged therein.

As shown in FIG. 1D, in its withdrawal position spear point 25 is pivoted 180 degrees such that the longitudinal axis 26 of spear point 25 is aligned with the longitudinal axis 27 of spear shaft 20 with point 50 facing inward within slot 16. Ball 30 contacts retaining mechanism 31 and is securely engaged therein.

As shown in FIG. 1C, in its retaining position spear point 25 is pivoted 90 degrees such that the longitudinal axis 26 of spear point 25 is aligned perpendicular to the longitudinal axis 27 of spear shaft 20. Ball 31 and 34 are both released from retaining mechanism 31.

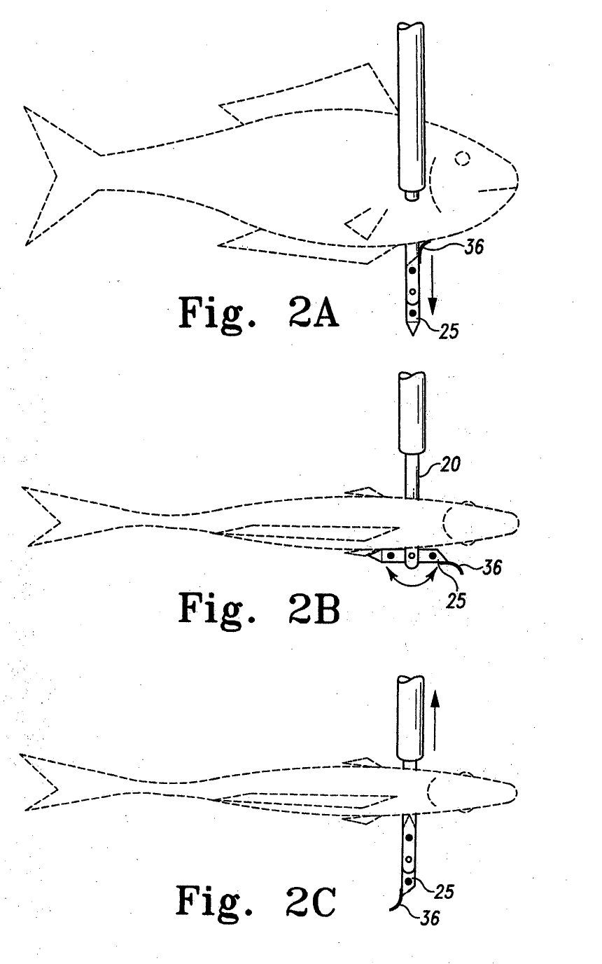

In operation, spear point 25 is manually pivoted and secured into its normal insertion position as shown in FIG. 1B, wherein ball 34 contacts ball lock mechanism 30 as shown in FIG. 2A and is securely engaged therewith. Spear point 25 pierces the body of the fish and exits through the other side of the body of the fish. As spear shaft 20 is withdrawn from the body of the fish, force is exerted against the retaining ear 36. This force exerted on to retaining ear 36 causes the spear point 25 to rotate clockwise 90 degrees as shown in FIG. 2B. Additionally, ball 30 is forced out of ball retaining mechanism 31. As spear point 25 rotates, it is aligned perpendicular to the longitudinal axis of spear shaft 20 as shown in FIG. 1C. Thus, the spear point 25 cannot be removed from the body of the fish.

To remove spear point 25 from the body of the fish, spear point 25 has to be manually pivoted in clockwise to the 180 degrees position wherein spear point 25 is in its withdrawal position as shown in FIG. 2C. Spear point 25 is manually pivoted within slot 16 with the apex point 50 facing the longitudinal axis of spear shaft 20 as shown in FIG. 1D. Then, spear point 25 can be removed from the body of the fish through the wound in the body of the fish. Additionally, ball 30 is securely engaged within ball lock mechanism 31. After removal of the fish the user rotates spear point 25 counter clockwise to the zero degree position.

What is claimed is:

1. A fishing spear assembly comprising:
an elongated spear shaft having a longitudinal axis with an upper and a lower end;
two parallel prongs spaced apart to a predetermined distance, the prongs integrally and linearly extending from the upper end to a predetermined distance within the spear shaft such that a slot is formed between the prongs;
a spear point having substantially a rectangular body defined by a longitudinal axis, a first side edge, an opposing second side edge, and an upper edge, the spear point body being positioned within the slot between the two parallel prongs and being pivotally attached thereto;
a triangular shape blade terminating in an apex point, the blade being affixed to the first side edge of the spear point;
the opposing second side edge being linearly and tapering upwardly and outwardly to the upper edge;
a retaining ear being securely affixed to the upper edge and slightly curved upward therefrom;

2. The assembly of claim 1 wherein the spear shaft further comprises a fastening means affixed to the lower edge of the spear shaft wherein the spear shaft can be releasably engaged with an elongated handle.

3. The assembly of claim 2 wherein the fastening means further comprises external threads affixed to the lower edge of the spear shaft.

4. The assembly of claim 1 wherein a securing pin laterally extends through the pair of prongs and a hole within the body of the spear point pivotally; the securing pin securing spear point therebetween.

5. The assembly of claim 1 further comprising a means of securing spear point in a set position between the pair of prongs.

6. The assembly of claim 5 wherein the means for securing further comprising:
a pair of balls permanently affixed on opposing sides of the body of the spear point;
a retaining mechanism affixed to at least one of the one of the pair of prongs;
and the retaining mechanism adapted to securely receive thereby securing spear point in a set position between the pair of prongs.

7. The assembly of claim 5 further comprising an insertion position wherein the spear point is pivoted to align the longitudinal axis of the spear point with the longitudinal axis of the spear shaft with the apex point extending outward of the two parallel prongs.

8. The assembly of claim 7 further comprising a retaining position wherein the spear point is pivoted 90 degrees from the insertion position to perpendicularly align the longitudinal axis of the spear point with the longitudinal axis of the spear shaft.

9. The assembly of claim 7 further comprising a withdrawal position wherein the spear point is pivoted 180 degrees from the insertion position with the apex point pointing inward within the slot between the pair of prongs.

10. The assembly of claim 6 wherein the retaining mechanism is an aperture through at least one prong of the spear shaft.
